(19) United States
(12) Patent Application Publication
(10) Pub. No.: US 2003/0071724 A1
(43) Pub. Date: Apr. 17, 2003

(54) Security system linked to the internet

(76) Inventor: Joseph N. D'Amico, Gardiner, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/251,652

(22) Filed: Sep. 20, 2002

Related U.S. Application Data
(63) Continuation of application No. 09/452,331, filed on Nov. 30, 1999, now abandoned.

(51) Int. Cl. G08B 29/00

(52) U.S. Cl. 340/506; 340/531; 340/521; 340/539

(57) ABSTRACT

A security network includes a security system having an alarm module coupled to a computer. The computer is coupled to a computer network. The alarm module can communicate to the computer network using the communication hardware and software of the computer. The computer network includes a security company server coupled to a security company and the Internet. This links the security system to the Internet and allows individuals to externally access the security system via the Internet. The security system also includes a plurality of remote sensors/transmitters to sense an alarm condition and to transmit wireless signals to the alarm module indicative of the alarm condition. When an alarm condition exists, the security system transmits an alarm signal to the security company server, and the security company server transmits e-mail or other information to the security system in response to the alarm signal. The status of the security system and alarm conditions can be monitored via the Internet.

### TECHNICAL FIELD

The present invention relates generally to security systems, and in particular, to a security system linked to the Internet.

### BACKGROUND OF THE INVENTION

Security systems are important for protecting a home or a business. They protect the premises not only against unauthorized intruders but also provide warnings when an emergency situation, like a fire, occurs in the premises. Security systems are often monitored via existing telephone lines by a remotely located security company. When an alarm condition occurs at the premises, such as an unauthorized entry or a fire, the security system transmits a signal to the security company via the telephone line, notifying the security company of the alarm condition. The security company then contacts the homeowner by telephone to verify whether the alarm condition is genuine or a false alarm. If the security company does not verify that the alarm condition is a false alarm, then the police or fire department is notified and sent to the premises.

Security systems need to be convenient to install, simple to use, and reliable. However, existing security systems suffer from many disadvantages and problems. For instance, a security system is activated and deactivated from a keypad mounted on a wall within the premises. This requires extra wiring and installation into an existing structure. Further, wall-mounted keypads often use different arrangements of buttons, and a degree of familiarity or training with the keypad may be required so that a proper security code or activation/deactivation sequence can be entered.

Existing security systems often cannot be accessed remotely by homeowner to allow the homeowner to remotely activate, deactivate, or verify the status of the security system. This is cumbersome in today's high-technology environment, where many activities and equipment need to be able to interface with a personal computer and/or with the Internet.

### SUMMARY OF THE INVENTION

An embodiment of the invention provides a security network comprising security system having a microprocessor and an alarm module coupled to the microprocessor. The security system includes a plurality of remote sensors, with one of the remote sensors transmitting an alarm signal to the alarm module if an alarm condition exists. The security network further comprises a server communicatively coupled to the microprocessor via a computer network, with the server receiving and storing an electronic message for a user. The microprocessor triggers a communication to the server if the alarm module receives an alarm signal from one of the remote sensors. In response to the communication triggered by the microprocessor, the server transmits the electronic message to the security system.

In one embodiment, the microprocessor comprises a part of a computer. In another embodiment, the microprocessor is communicatively coupled to a television unit. A display screen to display the electronic message is coupled to the microprocessor. The display screen can also display a visual warning associated with operation of the security system.

In another embodiment, a security network comprises security system having a microprocessor, an alarm module coupled to the microprocessor, a keyboard coupled to the microprocessor and operable to enter information associated with operation of the security system. The security network includes a server communicatively coupled to the microprocessor. The server has a network connection to allow a user to remotely access the security system.

An embodiment of the invention is a method of providing a security system communicatively coupled to a computer network. The method comprises coupling an alarm module to a computer, receiving at the alarm module alarm signals indicative of an alarm condition, sending a communication to a server in the computer network in response to the alarm condition, receiving and storing an electronic message for a user, and transmitting the electronic message from the server to the security system in response to the communication. The method can further comprise remotely accessing the alarm module via the server, and remotely checking a status of the alarm module or changing alarm settings.

Another embodiment of the invention provides a server in a communication network coupled security system having an alarm module, with the server comprising a computer-readable medium whose contents cause the server to receive and store an electronic message for a user, transmit the electronic message to the alarm module in response to receiving a communication from the alarm module indicative of an alarm condition, transmit an alarm signal to a security service in response to receiving the communication, and allow a user to remotely access information associated with the security system via the computer network.

A further embodiment of the invention provides a security alarm module coupleable to a microprocessor. The alarm module comprises a receiver to receive an alarm signal, an interface to the microprocessor, and a computer-readable medium whose contents allow the alarm module to communicate with the microprocessor through the interface. The alarm module sends a signal to the microprocessor if the alarm signal is received, and the alarm module receives computer network communications through the interface in response to transmitting the signal.

### BRIEF DESCRIPTION OF THE DRAWINGS

FIG. 1 is a block diagram illustrating an embodiment of a security system of the present invention.

FIG. 2 is a block diagram illustrating how an alarm module of the security system of FIG. 1 is coupled to a personal computer.

FIG. 3 is a block diagram illustrating how the security system of FIG. 1 is connected to a computer network.

FIG. 4 is a flowchart illustrating an embodiment of an arming process for the security system of FIG. 1.

FIG. 5 is a flowchart illustrating an embodiment of a disarming process for the security system of FIG. 1.

FIG. 6 is a block diagram illustrating an embodiment of an alarm module.

### DETAILED DESCRIPTION OF THE ILLUSTRATED EMBODIMENTS

Embodiments of the present invention provide a security system that is connected to a computer network, such as the Internet. This allows the security system to be operated from a computer and to be monitored via the Internet, while at the same time, providing a homeowner with a security system having electronic mail (e-mail) and remote-access capabilities.

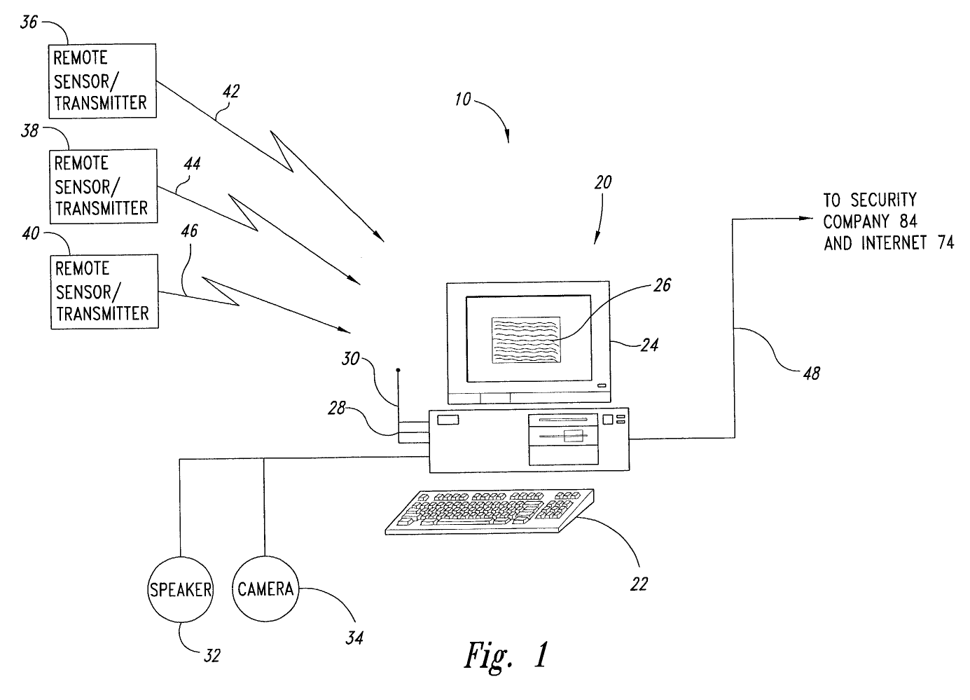

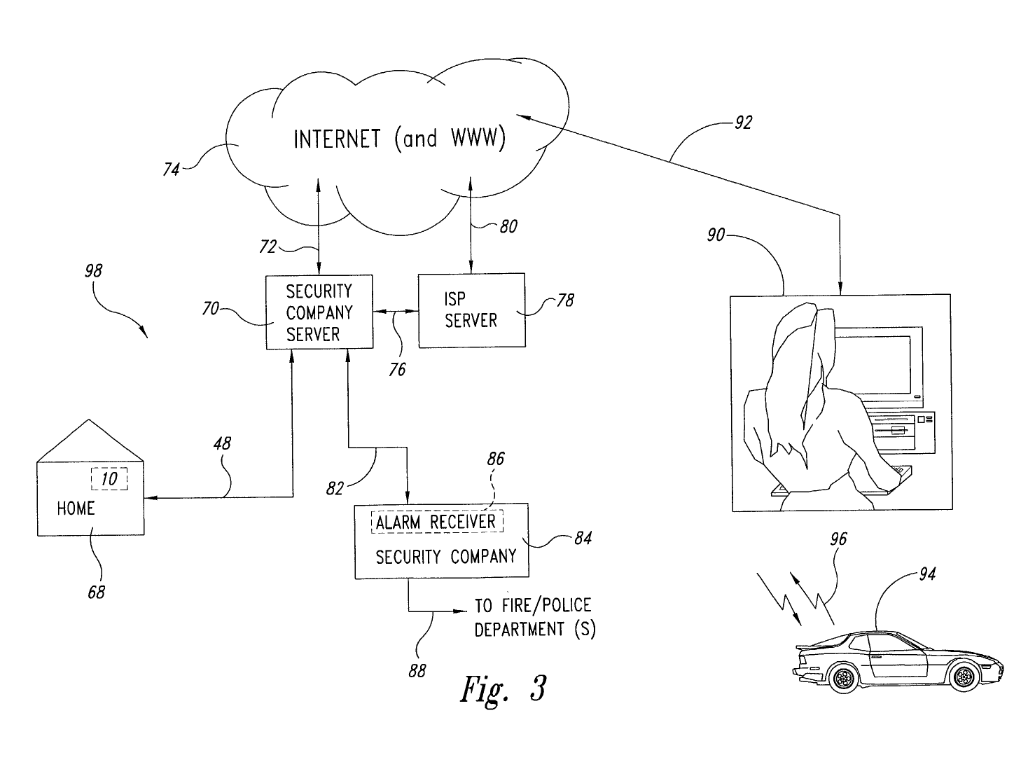

Referring first to FIG. 1, shown generally at 10 is an embodiment of a security system of the present invention. The security system 10 can be installed in a home, a business, apartments, recreational vehicles (RV), boats, or any other building or premises where security is desired. The security system 10 includes a device using a microprocessor, such as a personal computer (PC) 20 having a keyboard 22 and an output screen 24. The output screen 24 is operable to display one or more screen images 26, which can include screen icons, text and graphics, e-mail, etc. Although the PC 20 is described herein, it is to be appreciated that any type of microprocessor-controlled device that allows user input, connection to the Internet 74 (see, e.g., FIG. 3), or the display of screen images 26 can be used. These devices can include hand-held computers, workstations, “dumb” terminals connected to a mainframe computer via a network, laptop computers, wireless devices including enhance functionality wireless telephones, and television (TV) sets (such as WebTV™) that allow Internet access via a cable television line or a telephone line. Accordingly, the invention is not limited by the type of microprocessor-controlled device or terminal used by the security system 10

As is known, HyperText Markup Language (HTML) is a software language that allows the creation of pages on the World Wide Web (WWW) which can be viewed by connecting the PC 20 to the Internet 74. The PC 20 can store and run several types of software programs, including Internet communication software (including what is sometimes referred to as a “web browser”) that moves documents from the WWW to the PC 20 using a communication protocol known as HyperText Transfer Protocol (HTTP), thereby allowing the homeowner to view different web sites on the output screen 24. Connecting the PC 20 to the Internet 74 also allows the PC 20 to send and receive e-mail, using Simple Mail Transfer Protocol (SMTP) or Transmission Control Protocol/Internet Protocol (TCP/IP) communications. The PC 20 has one or more communication lines 48 that can be connected via a modem (not shown) to allow the PC 20 to communicate with outside networks, such as a remote security company 84 and the Internet 74 (see, e.g., FIG. 3).

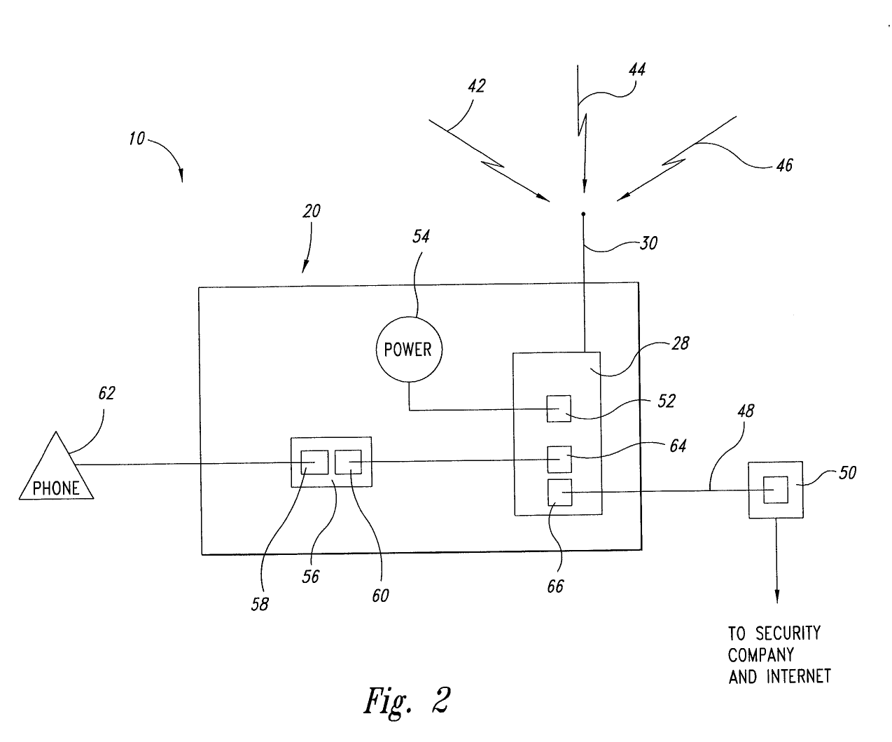

As will be described in further detail in FIG. 2, an alarm module 28 is coupled to the PC 20 via an input/output port of the PC 20. A speaker 32 and a camera 34 can also be coupled to the PC 20. The speaker 32 allows audible signals and warnings from the security system 10 to be broadcasted by the PC 20. The camera 34 can be a surveillance video camera that is activated when an alarm condition exists, takes surveillance “snapshots,” allows live person-to-person, (e.g., face-to-face) communication between the homeowner and remotely located security personnel, or other similar functions. It is also possible to provide interfaces from the PC 20 to other devices, such as to a radio.

The alarm module 28 includes an antenna 30 which forms part of a receiver circuit in the alarm module 28. A plurality of remote sensors/transmitters 36, 38, 40 are operable to detect an alarm condition and to transmit wireless signals 42, 44, 46, respectively, to the alarm module 28 when an alarm condition exists. The wireless signals 42, 44, 46 can be radio frequency (e.g., AM, FM, spread spectrum technology, cellular), infrared (IR), or microwave signals. The remote sensors/transmitters 36-40 are conventional, and can include sensors/transmitters that are triggered when a door or a window is opened or broken, smoke detectors with IR transmitters, wall-mounted TR motion sensors, hand-held “panic” devices, etc. Although only three remote sensors/transmitters 36-40 are shown in FIG. 1, it is to be appreciated that the security system 10 can have any number of these remote sensors/transmitters. Those skilled in the art will appreciate that an alarm condition may exist when only one of the plurality of remote sensors/transmitters 36-40 detects an alarm condition.

Additionally, although the remote sensors/transmitters 36-40 are shown as transmitting respective wireless signals 42-46 to the alarm module 28, it is to be appreciated that one or more of these remote sensors/transmitters 36-40 may have a hardwire connection to the alarm module 28. Consequently, the invention is not limited by the type, number, and connection of the remote sensors/transmitters 36-40 to the alarm module 28.

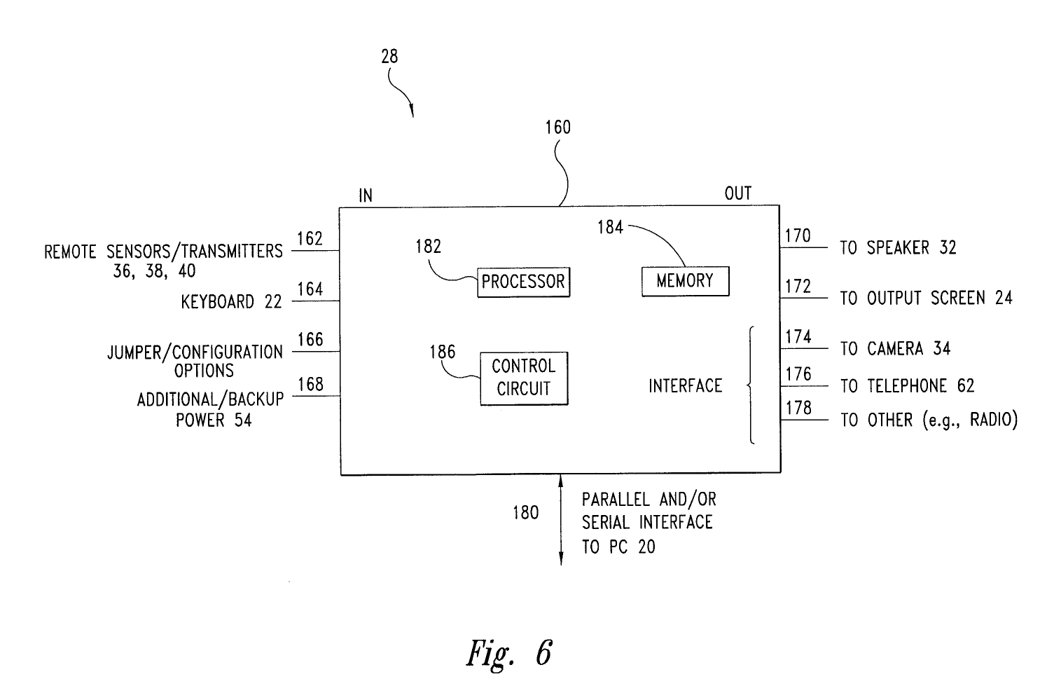

FIG. 2 is a block diagram illustrating how the alarm module 28 is coupled to the PC 20. The alarm module 28 comprises one or more cards that are inserted into a motherboard (not shown) of the PC 20. The card includes components (not shown) such as the receiver circuit, control circuits, logic circuits, memory, software, and other components that function to receive the wireless signals 42-46, to process these signals, and to interface with the hardware and software of the PC 20. The card will be described in further detail below with respect to FIG. 6. An operating system of the PC 20 recognizes the alarm module 28 as another peripheral device or as a network device, and provides an appropriate software interface with the alarm module 28 to allow the alarm module to function. The PC 20 can also store software specific to the operation of the alarm module 28 and which further provides functionality to the alarm module 28. A person skilled in the art would know how to configure the operating system of the PC 20 or the software associated with the alarm module 28 based on the description provided herein.

Memory used by the PC 20 (or the alarm module 28) can comprise many types of computer-readable media and associated devices that store data accessible by the PC 20 or by the alarm module 28, such as magnetic cassettes, digital video disks (DVDs), Bernoulli cartridges, random access memories (RAMs), read-only memories (ROMs), CD-ROMs, smart cards, etc., and these types of storage media can further store many types of operating system programs, one or more application programs, and other programs and data. Consequently, embodiments of the invention are not limited by the type of storage media and their associated devices, or by the specific type of software program stored therein.

The alarm module 28 receives its primary supply of power from the motherboard in the PC 20, via an AC power supply (not shown). The alarm module 28 also includes a power terminal 52 connected to a power source 54. The power source 54 can be a backup power source, such as a battery for the PC 20 or an uninterruptible power supply (UPS) that can filter power spikes and noise. The alarm module 64 has a first terminal 64 coupled to a terminal 60 of a port 56. The port 56 is a standard serial port, sometimes referred to as a COM port of the PC 20, and functions as the modem. The port 56 has another terminal 58 which is connected to a telephone 62. The alarm module 28 has a second terminal 66 which is connected by the communication line 48 to a telephone outlet/jack 50, which is in turn connected to the security company 84 and the Internet 74 via, for example, a Public Switched Telephone Network (PSTN) or other existing public telecommunication network. The outlet/jack 50 can have a dedicated line reserved for the security system 10. Having multiple terminals 64 and 66 allows the homeowner to concurrently use the telephone 62, browse the Internet, and use the security system 10.

The embodiments shown in FIGS. 1 and 2 allow the homeowner to use the keyboard 22 or other control device, such as a mouse (not shown), of the PC 20 to configure various alarm settings for the security system 10 and to otherwise operate the security system 10. For example, the homeowner can use the keyboard 22 to enter a security code to activate and deactivate the security system 10, instead of entering digits into a wall-mounted keypad such as those used by conventional security systems. Because the keyboard 22 is familiar to the homeowner and is commonly used for other computer-related activities, no special familiarization or training is required to use the keyboard 22 to operate the security system 10. Further, by coupling the alarm module 28 to the preexisting PC 20 and using the keyboard 22, the need to install a separate keypad and wiring into a wall is eliminated. The PC 20 and the keyboard 22 thus provide a convenient way to activate and deactivate the security system 10, as will be described in further detail below.

The output screen 24 allows information associated with the alarm module 28 or the security system 10 to be displayed as the screen image 26. For instance, if the remote sensor/transmitter 36 detects smoke, then the wireless signal 42 is transmitted to the alarm module 28. The alarm module 28 then triggers the output screen 24 to display the screen image 26, which can appear as a “FIRE!” text or graphic. The alarm module 28 can also trigger the PC 20 to play a siren or “FIRE!” on the speaker 32. Many combinations of visual and audible warnings are possible as a result of coupling the alarm module 28 to the PC 20.

As previously discussed, the alarm module 28 can communicate externally to the security company 84 or to the Internet 74 via the various communication hardware, software, and communication lines 48 associated with the PC 20. Similarly, outside individuals and/or externally located computers can communicate remotely with the alarm module 28 via the same communication lines 48 and the communication hardware and software associated with the PC 20. These communications are described in further detail below with reference to FIGS. 3-5.

FIG. 3 shows how the security system 10 in a home 68 can be connected to an external network 98, including a connection to the Internet 74 (and WWW) and to the security company 84. The home 68 has one or more of the communication lines 48 connected to a security company server 70. The communication lines 48 can comprise a continuous-Internet-access line (such as a line that allows the homeowner to initially log on to the Internet 74 and to remain online indefinitely without having to log off) and a separate voice line, a single line that multiplexes the data of an Internet session with a voice communication, or a single line that carries only data or only voice at a given time.

In the embodiment illustrated in FIG. 3, the security company server 70 is connected to the Internet 74 via a communication line 72. The security company server can also be connected to an Internet Service Provider (ISP) server 78 via a communication line 76. The ISP server 78 in turn can be connected to the Internet 74 via a communication line 80. By having the communication line 76 connecting to the ISP server 78, the homeowner can merge the services provided by security company 84 with existing services (e.g., e-mail and Internet access) provided by the homeowner's ISP. Alternatively, the home 68 may be connected directly to the Internet 74 and then connected to the security company server 70 via the Internet 74.

The security company server 70 is connected to the security company 84 via a communication line 82. Besides allowing the security company 84 to communicate with the PC 20 and the Internet 74, the connection to the security company server 70 via the communication line 82 also allows the security company 84 to function as an ISP and to provide alternative e-mail or Internet services to the home 68.

In another embodiment of the network 98, the home 68 can be connected first to the ISP server 78 via the communication line 48 and then to security company server 70, with the communication line 76 connecting the security company server 70 and the ISP server 78. Further, the communication line 82 can connect the security company 84 to either or both the security company server 70 and the ISP server 78. It is also understood that there may be multiple servers in the network 98 in addition to the security company server 70 and the ISP server 78 shown in FIG. 3. These multiple servers provide added capacity and routing options to the network 98. For simplicity of explanation throughout the description herein, the security system 10 will be described in the context of communicating with the security company server 70, and it is understood that other servers, such as the ISP server 78, may be involved in the communication as well. Thus, the security company 84 can communicate with the security system 10 via one or more servers, while bypassing other servers.

The security company server 70 includes one or more software programs that allow the security company server 70 to provide a communication interface between the PC 20, security company 84, and the Internet 74. These software programs can be any type of computer-readable or computer-executable instructions, such as program modules or macros executable by hardware in the security company server 70 or by other devices within or remote to the security company server 70. The software programs can be stored in many types of computer-readable media within or accessible to the security company server 70. Examples of these computer-readable media include those identified above with respect to description for the PC 20 and the alarm module 28

The home 68 can further have a separate communication line (not shown) to connect the security system 10 directly to the security company 84 and to other entities within a PSTN or within the external network 98. The separate communication line can be used, for example, if a direct connection to the security company 84 is desired without having to communicate in an Internet session via the security company server 70.

Although illustrated as conventional telephone lines, any of the communication lines shown in FIG. 3 can be high-speed data lines, such as lines from the family of Digital Subscriber Lines (xDSL) or Integrated Services Digital Network (ISDN) lines. Any of the communication lines can also be cable television lines, fiber-optic lines, wireless links (e.g., cellular telephone, optical, microwave or satellite links), or any combination of these. Consequently, the invention is not limited by the type of communication line or links.

The security company 84 has an alarm receiver 86 that processes alarm signals, status information, and other communications regarding the security system 10 that are sent to and from the home 68 via the external network 98. If the security company 84 determines that an alarm condition in the home 68 requires immediate action, the security company 84 can communicate with fire/police departments via a communication line 88. In one embodiment, personnel with the security company 84 may monitor the security system 10 (see FIG. 1) and contact the appropriate party when an alarm condition is detected. Such contact can occur via conventional telephone, the Internet 74 or any other convenient form of communication. In another embodiment, the security company 84 may be automated with no humans to monitor the security system 10. In this embodiment, a computer or other processor monitors the alarm system 10 and automatically sends a communication to the appropriate party when an alarm condition is detected. This communication may be in the form of e-mail or a voicemail message to a designated recipient (e.g., the police department).

The security company 84 maintains one or more databases (not shown) that track and log information associated with the security system 10, such as time of any alarm condition(s), whether the security system 10 is armed, power level of the security system 10, etc. The database can be located in the security company server 70, in the alarm receiver 86 of the security company 84, or in any other suitable location such that the information in the database can be accessed by or uploaded to the security company server 70 (e.g., accessed via the Internet 74). This database can also store other types of information, such as lists of authorized security codes, individuals (e.g., a neighbor) and organizations (e.g., the police department) to notify in the event of an alarm condition, addresses, telephone numbers, and other information that is pertinent to the security system 10 and that can be updated manually by the security company 84 or remotely by the user via the Internet 74.

From the network 98 shown in FIG. 3 and based on the embodiments and connections shown in FIGS. 1 and 2, it is evident that alarm information can be sent from the PC 20 in the home 68 to the security company 84, via the Internet 74. Also, because the security system 10, the security company 84, and the security company server 70 are all connected to the Internet 74, an authorized remote user 90 (such as a vacationing homeowner) can communicate to the security system 10 via a remote connection 92 to the Internet 74. Also, another authorized remote user 94 (such a homeowner using a mobile telephone in a vehicle) can communicate to the security system 10 via wireless communication links 96 to the Internet 74. These connections 92 and 96, respectively, provide the remote user(s) 90 and 94 with a useful and convenient way to remotely verify or change alarm settings or to arm/disarm the security system 10.

The remote users 90 and 94 can connect to the security system 10 using known remote log-in procedures and devices. For example, a laptop computer having a modem can be used to remotely dial an access telephone number associated with the security company server 70 or with the ISP server 78. Other possibilities include remotely connecting to the security system 10 via another PC (not shown) located at the homeowner's workplace. Video telephones and enhanced-functionality wireless devices are other examples of equipment that can be used to remotely access the security system 10 via the Internet 74.

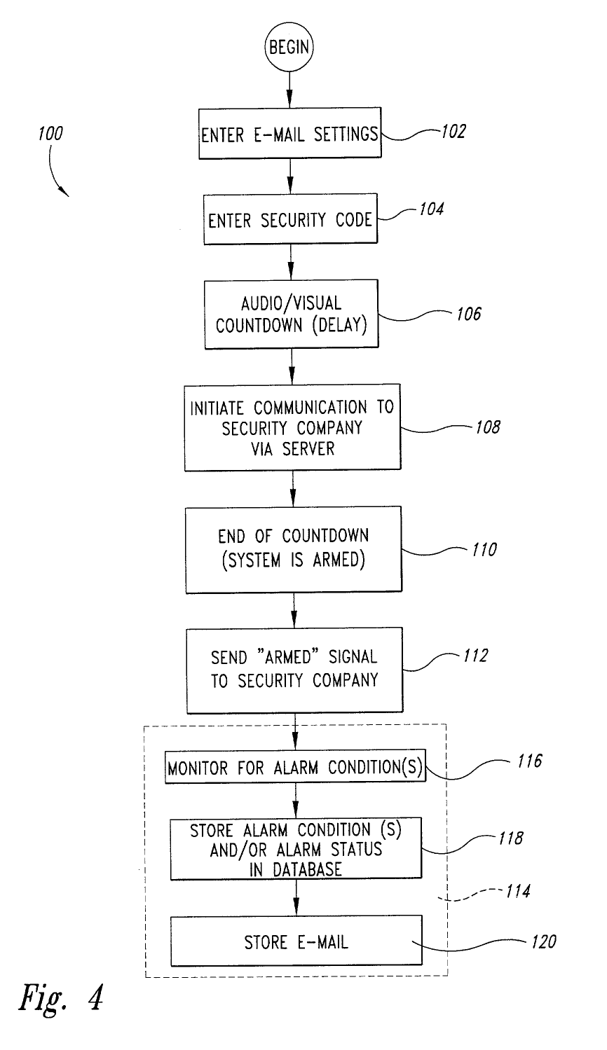

FIG. 4 illustrates an arming process 100 for the security system 10. Beginning at step 102, which is usually performed once but can be done any number of times, the homeowner enters e-mail settings using the keyboard 22 of the PC 20. These e-mail settings can include, for example, time periods when e-mail is to be delivered/downloaded to the PC 20 from the security company server 70 (see, e.g., FIG. 3). A default of the security system 10 is to deliver e-mail to the PC 20 from the security company server 70 whenever an alarm condition exists (e.g., when one of the remote sensors/transmitters 36-40 of FIG. 1 transmits a corresponding wireless signal 42-46). For instance, an alarm condition would exist if the security system 10 is armed and a door in the home 68 is opened. However, it may be cumbersome for the homeowner to have e-mail downloaded every time there is an entry into or exit from the home 68. Therefore, the e-mail settings can be modified such that e-mail is periodically forwarded from the security company server 70, such as, by way of example, every four hours. This time interval can be set by the homeowner and range, for example, from a few minutes to a few days.

At step 104, when the homeowner is ready to exit the home 68, the homeowner enters the security code using the keyboard 22 of the PC 20. This triggers a security system software in the PC 20 or in the alarm module 28 to execute an audio/visual countdown at step 106. This countdown is a delay that allows the homeowner to exit the home 68 before the security system 10 fully arms. An audio countdown can be played using the speaker 32, and a visual countdown can be displayed by the screen image 26 on the output screen 24 of the PC 20. While the countdown is occurring, the security system software in the PC 20 initiates a communication to the security company 84 at step 108, via the security company server 70. The communication is received by the alarm receiver 86 and provides information notifying the security company 84 that the security system 10 is arming.

At the end of the countdown, the security system 10 becomes fully armed at step 110. An “ARMED” signal is then sent from the PC 20 to the security company 84 at step 112. While the preceding steps 106-112 describe the communication to the security company 84 as occurring during the audio/visual countdown at step 106, it is to be appreciated that numerous variations to this arming process 100 are possible. For instance, the arming process 100 can be modified such that the initial communication to the security company 84 at step 108 does not occur until after the audio/visual countdown is completed at step 110. This modification allows the security system 10 to fully arm even before any type of communication is sent to the security company 84. It is also possible to modify the arming process 100 such that the communication is transmitted to the security company 84 as soon as the homeowner begins entering the security code at step 104, or alternatively, after the homeowner has keyed in the security code and clicked a “SEND” icon on the output screen 24. If the security code or other information is transmitted in this manner, the transmitted information can be encrypted for added security. In yet another alternative, the countdown is conducted by the security company 84, and an arming command is sent from the security company 84 to the security system 10 at the end of the countdown period. Therefore, the invention is not limited by the exact time or order when the communication to the security company 84 is transmitted.

Once the “ARMED” signal is sent at step 112 and the security system 10 is fully armed, alarm conditions are monitored at step 116 by the various remote sensors/transmitters 36-40. Any alarm condition(s) and/or alarm status data are stored in the database (not shown) of the security company 84, which can be accessed by or uploaded to the security company server 70. The database can be periodically updated by sending alarm status data from the PC 20 to the security company server 70, or by having the security company 84 “poll” the PC 20 for alarm status data. While the security system 10 is armed, the communication line 48 to the security company server 70 can be kept active (e.g., the PC 20 is kept “online” by using a continuous-Internet-access connection), thereby allowing the PC 20 to periodically transmit updated alarm information as the information becomes available or allowing the security company 84 to poll the PC 20. Alternatively, the communication line 48 can be activated only during alarm conditions or when status information is periodically transmitted on the communication line 48. In such a case, the PC 20 or the security company 84 conducts handshaking and hang-up procedures each time a transmission occurs over the communication line 48.

If any e-mail is received while the security system 10 is armed, the e-mail is stored at step 120 at the security company server 70 or at some other appropriate location in the network 98, such as at the ISP server 78. As described above, the e-mail can be delivered to the PC 20 from the security company server 70 when an alarm condition exists, such as when the returning homeowner opens a door.

Steps 116-120 can occur in any order or concurrently, and are generally denoted in FIG. 4 as step 114. Step 114 is continuously executed until an alarm condition occurs or until the security system 10 is disarmed. If an alarm condition occurs or if an alarm status changes, then an appropriate signal or alarm information is sent by the PC 20 to the security company server 70, and from there, sent to the alarm receiver 86. The security company 84 receives this signal or information and can take the appropriate action, including notifying the police and fire department(s). For instance, if there is a power outage that disables the PC 20, then the power source 54 (see, e.g., FIG. 2) can run the alarm module 28. During a power outage or if the power source 54 becomes depleted, a “LOW POWER” signal is sent to notify the security company 84. If an alarm condition occurs, such as a fire or an intruder, then a “FIRE” or “INTRUDER ALERT” signal is sent to the security company 84. All of these events are also logged in the database (not shown) at step 118 so that a record of these events can be kept and made accessible via the Internet 74. The information in the database can also be accessed via the Internet 74 and reviewed by authorized personnel, such as a vacationing homeowner, the security company 84, fire department, a neighbor watching over the home, etc The information in the database can also be periodically updated and automatically forwarded to these individuals.

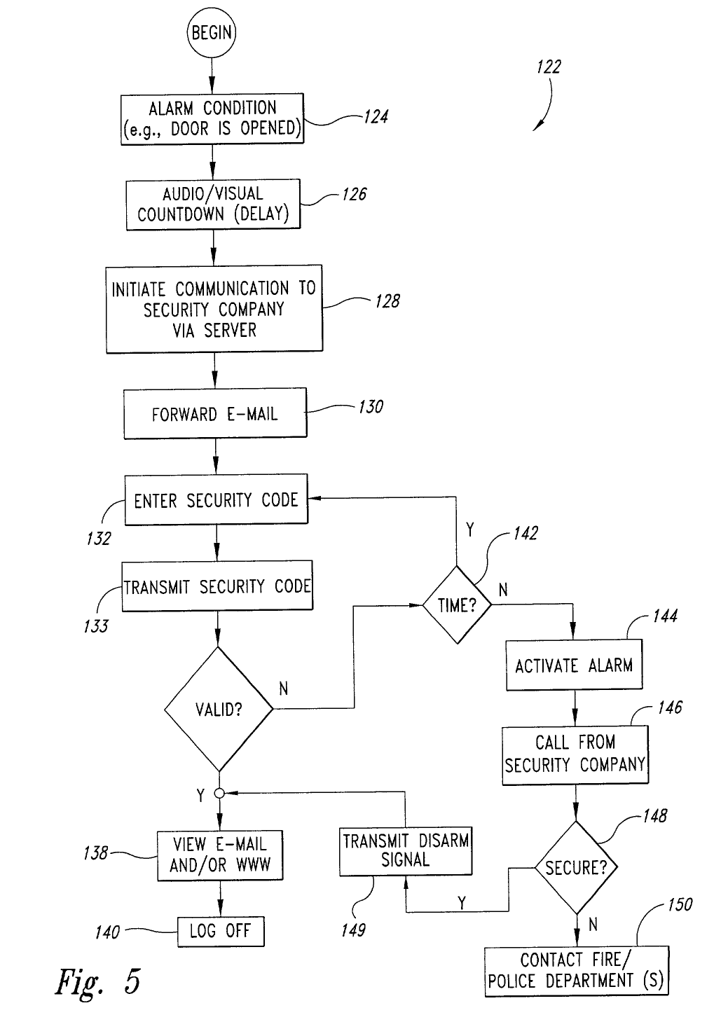

FIG. 5 illustrates a disarming process 122 for the security system 10. First, an alarm condition is triggered at step 124. This can happen when the homeowner returns to the home 68 and opens a door. In response, one of the remote sensors/transmitters 36-40 sends a respective wireless signal 42-46 to the alarm module 28, indicating to the alarm module 28 that an alarm condition exists. The alarm module 28 then triggers the PC 20 to begin an audio/visual countdown at step 126. Like step 106 in the arming process 100 of FIG. 4, the purpose of step 126 in the disarming process 122 of FIG. 5 is to provide the homeowner with a delay (such as 45 seconds) that is sufficient to allow the homeowner to disarm the security system 10. Besides visually displaying the countdown on the output screen 24, the PC 20 can also be set to trigger activation of the camera 44 or the speaker 32 at the start of the countdown.

At step 128, the PC 20 initiates a communication to the security company 84 via the security company server 70. This communication is subsequently received at the alarm receiver 86, which alerts the security company 84 of the alarm condition in the home 68. If the PC 20 is connected to the security company server 70 via a continuous-Internet-access connection, then the communication can be as simple as a packet of data transmitted along the communication line 48. If the connection is not continuous, then the PC 20 performs one or more conventional dialing and handshaking procedures to establish a connection with the security company server 70. The communication can include information such as the identity/address of the home 68, the type of alarm condition (e.g., fire or intruder), the time that the alarm condition was triggered, etc. The alarm receiver 86 can also perform a countdown concurrently or alternatively to the countdown in the home 68.

Once a connection is established with the security company server 70 and in response to the communication from the PC 20, the homeowner's e-mail can be forwarded from the security company server 70 or ISP server 78 to the PC 20 at step 130. Many possible options are available for forwarding the e-mail. One or more e-mail messages can be immediately downloaded from the security company server 70 to the PC 20, or the security company server 70 can hold the e-mail and transmit just a notification that will appear on the output screen 24 of the PC 20, with the notification saying that new and unread e-mail is present. Another alternative option is to have the e-mail or e-mail notification forwarded only after the disarming process 122 is completed.

At step 132 and while the countdown is occurring, the homeowner enters the security code to disarm the security system 10. As with step 104 in the arming process 100 of FIG. 4, the homeowner enters the security code by using the keyboard 22 of the PC 20. The output screen 24 can display a graphical interface or text field where the homeowner can enter the security code. Once the alphanumeric characters for the security code are entered by the homeowner, the PC 20 transmits the security code to the security company server 70 when the homeowner presses “ENTER” on the keyboard 22 or clicks a “SEND” icon appearing on the output screen 24. The user-entered security code is transmitted to the security company 84 in step 133.

At step 134, the alarm receiver 86 in the security company 84 receives the transmitted security code from the security company server 70 and verifies if the security code is valid. If the security code is valid, then the alarm receiver 86 can disarm the security system 10 by transmitting a disarming signal to the PC 20, which the PC 20 then relays to the alarm module 28.

Afterwards, at step 138, the PC 20 remains connected to the Internet 74, and an Internet web page of the homeowner's ISP or some other web page appears as the screen image 26 on the output screen 24. From this web page, the homeowner can access and read the e-mail received from the security company server 70 and/or view pages on the WWW (sometimes referred to as “web surfing”). After the Internet session is completed, the homeowner can log off at step 140 Alternatively, if the homeowner has a continuous-Internet-access connection, then the homeowner can simply proceed to do other activities in the home 68 without having to log off.

If the user-entered security code is determined to be invalid at step 134, then the security system 10 (or the alarm receiver 86) makes a determination as to whether there is still time remaining in the countdown at step 142. If time still remains in the countdown, then the homeowner can re-enter the security code at step 132, and the process repeats as previously described above.

If no time remains at step 142, then an alarm is activated at step 144. The alarm can include playing a loud siren with the speaker 32 and/or activating the camera 34 to begin recording surveillance images. The alarm can be independently activated by software in the alarm module 28 or in the PC 20, or the alarm receiver 86 in the security company 84 can transmit a message to the PC 20 instructing the PC 20 to remotely activate the alarm. While the preceding has described how an alarm is activated at step 144 if the homeowner does not enter a valid security code within the time limit of the countdown, it is understood that the time limit may lapse without any security code ever being entered into the PC 20. This would occur if an intruder does not know the security code or does not know that the security system 10 needs to be deactivated by entering the security code using the keyboard 22. As mentioned, the countdown can be performed by either or both the security system 10 in the home 68 or by the alarm receiver 86.

At step 146 and in response to the alarm activated at step 144, the security company 84 places a telephone call, via a live security company operator or a prerecorded message, to the home 68 to verify if the alarm condition is genuine or a false alarm. Instead of a telephone call, it is also possible for the security company 84 to remotely view the premises via the camera 34, provide a real-time (e.g., live) operator's image on the output screen 24 of the PC 20 that asks the homeowner to verify the alarm condition, transmit an “ARE YOU OKAY? PLEASE VERIFY ALARM” e-mail, or do other types of verification procedures. If the security company 84 determines at step 148 that the premises are not secure, then the security company 84 contacts the fire and/or police departments at step 150, via telephone, e-mail, or other communication methods. The security company 84 can also send e-mail to one or more recipients notifying them of the alarm condition. For example, the homeowner can configure the security system 10 such that the security company 84 forwards alarm notification e-mails to neighbors and relatives.

However, the security company 84 may confirm the identity of the homeowner by a number of well-known techniques, such as a secret password, mother's maiden name, or other personal identification information. If back at step 148, the security company 84 confirms (e.g., by speaking directly to the homeowner) that the alarm condition is a false alarm, then the security company 84 can disarm the security system 10 by transmitting the disarming signal at step 149. Thereafter, the homeowner can review e-mail or surf the WWW at step 138 as described above.

Many possible variations can be made to the disarming process 122 of FIG. 5. The exact order of when the different steps shown in the disarming process 122 is not crucial to the invention, and several other steps can be added, removed, changed, or combined in the disarming process 122. For instance, the communication to the security company 84 via the security company server 70 shown at step 128 can be delayed until after a security code is successfully entered. That is, the homeowner enters the security code at step 132, and if the alarm module 28 determines that the security code is valid, then afterwards, the initial communication to the security company 84 is made, accompanied by the forwarding of e-mail and other Internet communication to the PC 20. Another option, if the security code is successfully entered, is to eliminate any communication to the security company 84 and simply trigger just a connection to the Internet 74 via the security company server 70. With this option, the alarm module 28 determines that the security code is valid, disarms the security system 10, and triggers a connection to the security company server 70 for e-mail and web surfing, without ever having to complete a communication to the alarm receiver 86.

While the arming process 100 and the disarming process 122 are described herein in the context of sending various alarm signals and communications to and through the security company server 70, it is to be appreciated that many other possible communication routes can be used. For instance, the various alarm signals and communications can be sent first through the ISP server 78 and then to the security company server 70, the security company 84 can bypass the security company server 70 by directly communicating to the security system 10 using the ISP server 78, the ISP server 78 can perform all of the functions of the security company server 70 described herein, some e-mail and alarm signals and communications can be selectively routed to either or both of the ISP server 78 and the security company server 70, etc Consequently, the present invention is not limited by the particular server used, the number of servers used to route e-mail and alarm signals and communications, the specific functions or communications performed by a given server, or the particular network route used to carry the e-mail and alarm signals and communications

The security system 10 can also be provided with remote arming and disarming features. That is, the absent homeowner (e.g., the remote user(s) 90 and 94) can remotely disarm the security system 10 to allow a neighbor to enter the home 68, and then remotely re-arm the security system 10 when the neighbor exits the home 68. The security system 10 can also provided with features that allows the remote user(s) 90 and 94 to remotely enter the security code to disarm the security system 10 should a neighbor enter the home 68 when the security system 10 is armed and then accidentally trigger one of the remote sensors/transmitters 36-40.

It is further appreciated that other information can be provided to the homeowner in addition to or instead of e-mail. For example, the homeowner may choose to set the security system 10 such that the homeowner's daily stock portfolio or favorite web site appears after the security system 10 is disarmed. Any type of trackable or online information can be displayed on the PC 20 (as the screen image 26) after the security system 10 is disarmed, including the location of a spouse's vehicle (e.g., by connecting a global positioning system (“GPS”) of the vehicle to the Internet 74), bus schedules, weather reports, or sports information.

An online “training” video or other technical support information about the security system 10 can be provided to the homeowner by the security company 84 via the PC 20 and the security company server 70. For instance, online video images showing the steps to arm the security system 10 can be transmitted to the PC 20 if requested by the user.

Additionally, multiple security systems 10 installed in a plurality of homes 68 or apartments may be connected together and mutually accessible via the Internet 74. This allows the user of one PC 20 to view the security status of a plurality of security systems 10. Therefore, the homeowner can tell if the neighbor has an armed security system 10 or currently has an alarm condition, like a burglary or fire. Similarly, the neighbor can view the alarm status or alarm conditions of the homeowner and of other neighbors on the neighbor's PC 20. Other possible shared features can include presenting a general map of the homeowner's neighborhood showing power outages or the status of a plurality of neighbors' security systems 10. Many features and variations are possible to share information, and any individual homeowner has the option not to have his/her security system 10 (or other individual alarm information) included within the shared network so that information about the individual homeowner's security system 10 is not made public to the other homeowners in the shared network. Alternatively, the homeowner can have the option of selecting specific homeowners with whom to share security system information or to notify in the event of an alarm condition.

FIG. 6 is a block diagram illustrating an embodiment of the alarm module 28 that can implement the various features described above. The alarm module 28 comprises one or more cards 160 that can be connected to the PC 20. The card 160 includes a plurality of inputs 162-168. The input 162 is connected to the remote sensors/transmitters 36-40 to receive the respective alarm signals 42-46. The input 164 interfaces with the keyboard 22 of the PC 20 to receive user input associated with operation of the security system 10. The card 160 can further have a jumper/configuration option input 166 to allow the homeowner or security company 84 to make additional configurations to the security system 10. Additional power or backup power can be provided by the power supply 54 through the input 168.

The card 160 includes a plurality of outputs 170-178. The output 170 provides an interface to the speaker 32, and the output 172 provides an interface to the output screen 24 of the PC 20. Similarly, the outputs 174 and 176 provide interfaces to the camera 34 and the telephone 62, respectively The card 160 can have an output 178 that interfaces the card 160 with other devices, such as a radio. An interface 180 provides parallel and/or serial interface to the PC 20.

Some of the on-board components of the card 160 include a processor 182 and a memory 184. The card 160 can also include a control circuit 186 that cooperates with the processor 182 and the memory 184 to receive, process, and transmit alarm information. Other components of the card 160 are not shown in FIG. 6 because they are conventional or would be known to those skilled in the art based on the description provided herein.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize The teachings provided herein of the invention can be applied to other security systems, not necessarily the illustrative security system linked to the Interned described above.

Aspects of the invention can be modified, if necessary, to employ other systems, circuits, and concepts to provide yet further embodiments of the invention. For instance, the security system 10 may have a “BYPASS” mode that allows individuals to stay inside the home 68 while the security system 10 is armed, without triggering an alarm condition from an IR motion detector (e.g., the sensor/transmitter 38). This is useful, for example, when the homeowner's family is sleeping at night or when the homeowner wishes to leave children inside the home 68, while still keeping the security system 10 active against intruders. The “BYPASS” mode can also allow the individual inside the home 68 to use the PC 20 (e.g., surf the WWW) while the security system 10 is armed. In such a case, this Internet session can be: a) multiplexed (via the same communication line 48) with alarm monitoring signals that are sent to and from the security server 70, b) conducted concurrently with the alarm monitoring signals via separate communication lines, or c) conducted while communication with the security server 70 is suspended (and the security system 10 is still kept armed). If an alarm condition should occur (e.g., an intruder enters the home 68) while the homeowner is having the Internet session, then the security system 10 can automatically suspend or end the Internet session so that a communication to the security server 70, indicating an alarm condition, can be transmitted. This can be accompanied by a pop-up window on the output screen 24 of the PC 20, such as “WARNING! AN ALARM HAS BEEN TRIPPED!” that immediately notifies the homeowner of the situation.

Another possible embodiment of the invention is to connect the security system to other types of computer networks besides the Internet, such as local area networks (LANs) or Intranets. As an example, a company can establish their own internal security service which links a plurality of employees' PCs 20 to a server and to a central monitoring station. The remote monitoring, e-mail, alarm, and disarming procedures described above function similarly in this Intranet-type of system. The internal security service can be in turn connected to external security services, thereby allowing multiple security services to communicate with each other.

These and other changes described above can be made to the invention in light of the detailed description herein. In general, in the following claims, the terms used should not be construed to limit the invention to the specific embodiments disclosed in the specification and the claims, but should be construed to include all security systems that operate under the claims to provide, inter alia, a communication to a computer network. Accordingly, the invention is not limited by the disclosure, but instead the scope of the invention is to be determined entirely by the following claims, which are to be construed in accordance with established doctrines of claim interpretation.

What is claimed is:

1. A security network, comprising:
a security system having:
a microprocessor;
an alarm module coupled to the microprocessor; and
a plurality of remote sensors to sense alarm conditions and to transmit alarm signals to the alarm module, one of the plurality of remote sensors transmitting an alarm signal to the alarm module if an alarm condition sensed; and
a server communicatively coupled to the microprocessor via a computer network, the server receiving and storing an electronic message for a user, the microprocessor triggering a communication to the server if the alarm module receives the alarm signal from one of the remote sensors, the server transmitting the electronic message to the security system in response to the communication.

2. The security network of claim 1 wherein the microprocessor is communicatively coupled to a television unit.

3. The security network of claim 1, further comprising a display screen coupled to the microprocessor, the display screen displaying the electronic message.

4. The security network of claim 1, further comprising a display screen coupled to the microprocessor, the display screen displaying a visual warning associated with operation of the security system.

5. The security network of claim 1, further comprising an audio speaker coupled to the microprocessor, the audio speaker operable to play an audible warning associated with operation of the security system.

6. The security network of claim 1 wherein the server includes a network connection to allow a user to remotely access the alarm module to review or change alarm settings.

7. The security network of claim 1, further comprising a remotely located receiver communicatively coupled to the server, the receiver operable to process the communication and to trigger the server to transmit the electronic message.

8. The security network of claim 1, further comprising a keyboard coupled to the microprocessor to allow entry of a security code to change a status of the security system.

9. The security network of claim 1 wherein the electronic message comprises e-mail or an HTML transmission.

10. The security network of claim 1 wherein the security system further transmits a message to a remote location different from the server and the alarm module in response to the receipt of the alarm signal by the alarm module.

11. The security network of claim 10 wherein the security system automatically transmits the message to the remote location.

12. A security network, comprising:
a security system having
a microprocessor;
an alarm module coupled to the microprocessor; and
a keyboard coupled to the microprocessor; the keyboard operable to enter alarm information associated with operation of the security system; and
a server communicatively coupled to the microprocessor, the server having a network connection to allow a user to remotely access the security system.

13. The security network of claim 12 wherein the security system further comprises a plurality of remote sensors to transmit an alarm signal to the alarm module if an alarm condition exists, the microprocessor triggering a communication to the server if the alarm module receives the alarm signal from one of the remote sensors, the server receiving and storing an electronic message for a user, the server transmitting the electronic message to the security system in response to the communication.

14. The security network of claim 12 wherein the microprocessor comprises a part of a computer.

15. The security network of claim 12 wherein the microprocessor is communicatively coupled to a television unit.

16. The security network of claim 12, further comprising a display screen coupled to the microprocessor, the display screen displaying an electronic message transmitted from the server.

17. The security network of claim 12, further comprising a display screen coupled to the microprocessor, the display screen displaying a visual warning associated with operation of the security system

18. The security network of claim 12, further comprising an audio speaker coupled to the microprocessor, the audio speaker operable to play an audible warning associated with operation of the security system.

19. The security network of claim 12, further comprising a remotely located receiver, the receiver communicatively coupled to the server, the receiver operable to receive a communication from the alarm module and to transmit alarm information to the server for access by the user.

20. The security network of claim 12 wherein the security system further transmits a message to a remote location different from the server and the alarm module in response to the receipt of the alarm signal by the alarm module.

21. The security network of claim 20 wherein the security system automatically transmits the message to the remote location.

22. A server in a computer network communicatively coupled to security system having an alarm module, the server comprising a computer-readable medium whose contents cause the server to:
receive and store an electronic message for a user;
transmit the electronic message to the security system in response to receiving a communication from the security system indicative of an alarm condition;
transmit an alarm signal to a security service in response to receiving the communication, the alarm signal indicative of the alarm condition; and
allow a user to remotely access information associated with the security system via the computer network.

23. The server of claim 22 wherein the electronic message comprises e-mail or an HTML transmission.

24. The server of claim 22 wherein the server is communicatively coupled to another server.

25. An security alarm module coupleable to a microprocessor, the alarm module comprising:
a receiver to receive an alarm signal;
an interface to the microprocessor; and
a computer-readable medium whose contents allow the alarm module to communicate with the microprocessor through the interface, the alarm module sending a signal to the microprocessor if the alarm signal is received, the alarm module receiving computer network communications through the interface in response to transmitting the signal.

26. The alarm module of claim 25 wherein the contents allow the microprocessor to trigger an audiovisual warning if the alarm signal is received.

27. The alarm module of claim 25 wherein the contents allow the microprocessor to trigger an audiovisual warning if the alarm module is in an arming process.

28. The alarm module of claim 25, further comprising a communication interface to a computer network.

29. A method of providing a security system communicatively coupled to a computer network, the method comprising:
coupling an alarm module to a microprocessor;
receiving at the alarm module alarm signals indicative of an alarm condition;
sending a communication to a server in the computer network in response to the alarm condition;
receiving and storing an electronic message for a user at a server; and
transmitting the electronic message from the server to the security system in response to the communication.

30. The method of claim 29, further comprising sending an additional communication to a remote location different from the server and the alarm module in response to the alarm condition.

31. The method of claim 30 wherein the additional communication is automatically sent to the remote location and comprises a selected one of a voicemail communication and an e-mail communication.

32. The method of claim 29, further comprising:
remotely accessing the alarm module via the server; and
remotely changing alarm settings associated with operation of the security system.

33. The method of claim 29, further comprising providing audiovisual warnings in response to the alarm condition.
